(19) United States
(12) Patent Application Publication
(10) Pub. No.: US 2011/0053567 A1
(43) Pub. Date: Mar. 3, 2011

(54) Click to call browser functionality

(76) Inventor: Michael J. Ure, Cupertino, CA (US)

(21) Appl. No.: 12/551,806

(22) Filed: Sep. 1, 2009

(51) Int. Cl. H04W 4/00

(52) U.S. Cl. 455/414.1

(57) ABSTRACT

Telephone numbers are displayed within a browser window as active links that can be clicked on or otherwise activated. Telephone capabilities of the device being used are then activated to automatically dial the selected telephone number. The device may be a smartphone, a personal computer, etc.

### BACKGROUND

1. Field of the Invention

The present invention relates to telephony including stationary telephony, mobile telephony and computer telephony.

2. State of the Art

A common element of web sites is a Contact link that displays contact information, often including one or more telephone numbers. Heretofore, telephone numbers have typically been displayed as passive information. To make telephone contact, the user is required to manually dial the displayed number.

### SUMMARY

The present invention, generally speaking, provides for the display of telephone numbers within a browser window as active links that can be clicked on or otherwise activated. Telephone capabilities of the device being used are then activated to automatically dial the selected telephone number. The device may be a smartphone, a personal computer, etc.

### DESCRIPTION OF DRAWING

The foregoing may be further understood from the following description in conjunction with the appended drawing. In the drawing:

FIG. 1 is a block diagram of an electronic device having click to call capabilities.

FIG. 2 is a more detailed block diagram of the electronic device of FIG. 1.

FIG. 3 is a diagram illustrating click to call functionality.

FIG. 4 is a further diagram illustrating click to call functionality.

### DETAILED DESCRIPTION

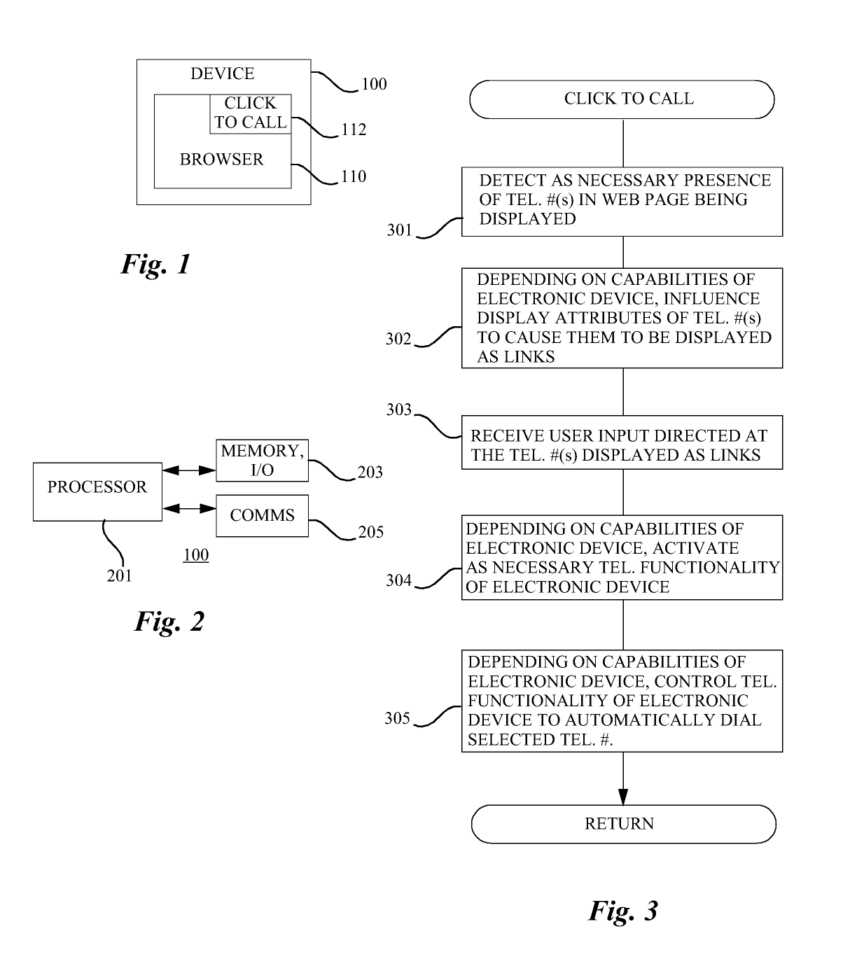

Referring now to FIG. 1, a block diagram is shown of an electronic device 100 provided with a web browser 110 having click to call browser functionality 112. The electronic device 100 may be any electronic device capable of running a web browser. For example, the electronic device 100 may be a mobile electronic device such as a smartphone, feature phone, or other cellular telephone, a mobile computer such as a notebook or netbook computer, etc. Alternatively, the electronic device 100 may be a more stationary electronic device such as a desktop computer, an IP phone, an IP TV, etc.

Referring to FIG. 2, the electronic device 100 of FIG. 1 may be provided with a processor 201, memory and I/O devices 203, and communication devices 205. Memory and I/O devices 203 may include memory subsystems, a touchscreen such as a capacitive, resistive, or other (e.g., DuoTouch™) touchscreen, a keyboard or keypad, a speaker, a microphone, buttons, haptic actuators, etc. In some instances, the processor 201 may be combined with some (or all) of the I/O devices 203 and/or communication devices 205. Communication devices 205 may include a wireless or wired transceiver for PAN, LAN and/or WAN communications. Software installed on the electronic device 100, in addition to an operating system and a web browser, may include telephony software (i.e., a telephony application) such as software identified by the tradenames Skype™, Google Voice™, etc., which may be user-installable.

Referring again to FIG. 1, the web browser 110 is provided with click to call functionality 112, either native to the web browser 110 or in the form of an extension or plug-in. A memory subsystem (I/O devices 203) may include both mass storage and execution memory, with the web browser 110 and the click to call functionality being stored at least in part in execution memory during web browsing. Referring to FIG. 3, the click to call functionality 112 may include some or all of the following functions:
1. Detects as necessary the presence of telephone numbers in a web page being displayed (301).
2. Depending on the telephony capabilities of the electronic device, influences the display attributes of the telephone numbers to cause them to be displayed as links (302).
3. Receives user input directed at the telephone numbers displayed as links (303).
4. Depending on the telephony capabilities of the electronic device, activates as necessary telephone functionality of the electronic device (304).
5. Depending on the telephony capabilities of the electronic device, controls the telephone functionality of the electronic device to automatically dial the selected telephone number (305). If desired, Session Initiation Protocol (SIP) may be used for this purpose.

The operations performed by the click to call functionality 112 may vary depending on the coding or scripting of the web page, the capabilities of the electronic device 100, etc. For example, some web pages may explicitly identify telephone numbers and cause them to be displayed as links A mechanism may be provided whereby clicking the link causes the telephone number to be dialed. The mechanism may be entirely local (and may make use of an exception handler, for example), or may involve a remote web server. Any of a variety of possible mechanisms may be employed.

Other web pages may simply display telephone numbers as text. In this case, the click to call functionality 112: detects as necessary the presence of telephone numbers in a web page being displayed; depending on the telephony capabilities of the electronic device, influences the display attributes of the telephone numbers to cause them to be displayed as links; and receives user input directed at the telephone numbers displayed as links.

Some electronic devices 100 may be browser capabilities but not telephone capabilities. In this case, preferably, telephone numbers are not displayed as links but are displayed simply as text.

If the electronic device 100 is a smartphone, the telephone function is always active and available. If the electronic device 100 is a computer, then it may be necessary to activate a telephony application. Preferably, any required user interaction with the telephony application is pre-scripted to avoid the need for any live user input.

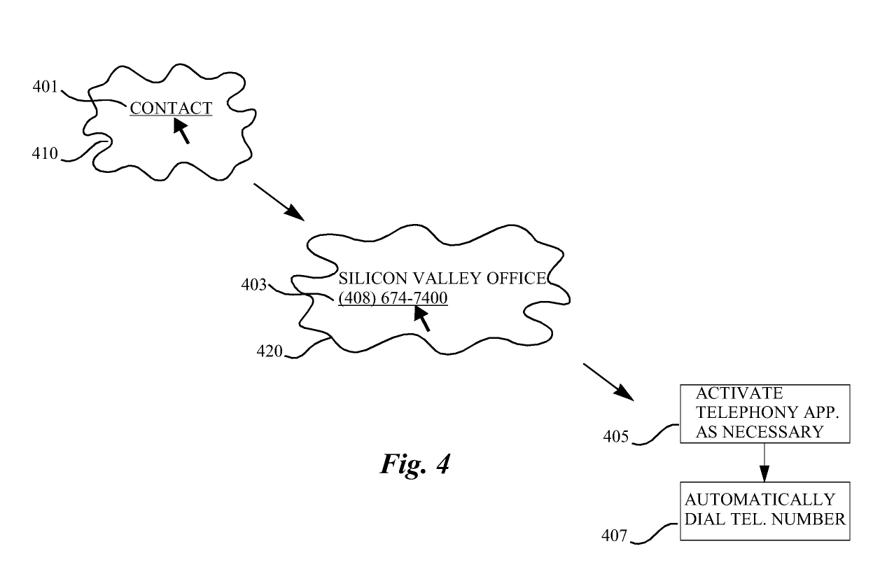

An example application of the described click to call functionality is shown in FIG. 4. A user clicks on a Contact link 401 within a web page 410 (only a portion of which is shown). A further web page 420 (only a portion of which is shown) is displayed that includes contact information including a telephone number. The telephone number is displayed as a link 403. The user clicks on the telephone number. As a result, a telephony application is activated if necessary (405), and the telephone number is automatically dialed (407).

Although embodiments of the present invention have been described in detail, it should be understood that various changes, substitutions and alternations can be made without departing from the spirit and scope of the inventions as defined by the appended claims.

What is claimed is:

1. A method comprising:
displaying on a device a web page, the web page comprising a telephone number, the telephone number being displayed as a link to prompt a user to click on or otherwise select the telephone number;
receiving an input as a result of a user clicking on or otherwise selecting the telephone number; and
in response to the input, automatically dialing the telephone number using telephony capabilities of the device.

2. A device comprising:
a processor, a memory coupled to the processor, a display coupled to the processor, and a communications circuit coupled to the processor;
a web browser stored at least in part in said memory for displaying on the device a web page, the web page comprising a telephone number, the telephone number being displayed as a link to prompt a user to click on or otherwise select the telephone number;
an input device coupled to said processor for receiving an input as a result of a user clicking on or otherwise selecting the telephone number; and
instructions stored at least in part in said memory for, in response to the input, automatically dialing the telephone number using telephony capabilities of the device.

3. A computer readable medium comprising instructions for:
displaying on a device a web page, the web page comprising a telephone number, the telephone number being displayed as a link to prompt a user to click on or otherwise select the telephone number;
receiving an input as a result of a user clicking on or otherwise selecting the telephone number; and
in response to the input, automatically dialing the telephone number using telephony capabilities of the device.

4. The method of claim 1, wherein the telephony capabilities of the device are provided by a user-installable telephony application.

5. The device of claim 2, wherein the telephony capabilities of the device are provided by a user-installable telephony application.

6. The computer readable medium of claim 3, wherein the telephony capabilities of the device are provided by a user-installable telephony application.

7. The method of claim 1, wherein the telephone number is identified as a link using at least one of color variation and underlining.

8. The device of claim 2, wherein the telephone number is identified as a link using at least one of color variation and underlining.

9. The computer readable medium of claim 3, wherein the telephone number is identified as a link using at least one of color variation and underlining.
